(19) United States
(12) Patent Application Publication
(10) Pub. No.: US 2016/0095157 A1
(43) Pub. Date: Mar. 31, 2016

(54) COMMUNICATION TERMINAL AND METHOD FOR PERFORMING A COMMUNICATION

(71) Applicant: Intel IP Corporation, Santa Clara, CA (US)

(72) Inventors: Dietmar Wenzel, Munich (DE); Matthias Obermeier, Taufkirchen (DE); Michael Esch, Nuernberg (DE)

(21) Appl. No.: 14/497,444

(22) Filed: Sep. 26, 2014

(51) Int. Cl. H04W 76/04; H04B 1/38; H04L 29/08

(52) U.S. Cl. CPC H04W 76/04; H04L 69/325; H04B 1/38

(57) ABSTRACT

A communication terminal is described comprising a transceiver configured to establish a layer three communication connection and to transmit data via the layer three communication connection and a controller configured to control the transceiver to pause data transmission of the layer three communication connection, transmit data via a second communication connection during the pausing of the data transmission of the layer three communication connection and resume transmission of data via the layer three communication connection after the transmission of data via the second communication connection is completed.

### TECHNICAL FIELD

Embodiments described herein generally relate to communication terminals and methods for performing a communication.

### BACKGROUND

A mobile terminal may support communication by means of different radio access technologies (RATs) and the usage of a plurality of subscriber identity modules (SIMs). Typically, when there is an active communication for one subscriber identity module or via one radio access technology, services for another subscriber identity module or another radio access technology are limited. Approaches that allow avoiding such limitations are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication system according to a mobile communication standard, such as LTE.

FIG. 2 shows a radio cell arrangement according to an embodiment illustrating an overlapping coverage of two communication networks.

FIG. 3 shows the high level architecture of a communication terminal for a DSDA system.

FIG. 4 shows the high level architecture for a communication terminal for a combined SSDA and DSDA system.

FIG. 5 shows the high level architecture of a communication terminal for a DSDS system.

FIG. 6 shows a communication terminal.

FIG. 7 shows a flow diagram illustrating a method for performing a communication, e.g. carried out by a communication terminal.

FIG. 8 shows a high level architecture of a communication terminal for a combined SSDA plus DSDA light with TxT system.

FIG. 9 shows an example of an architecture of a modem.

FIG. 10 shows a timing diagram for a realization of a first transmit toggling approach.

FIG. 11 shows a timing diagram for a realization of a second transmit toggling approach.

FIG. 12 shows a timing diagram for a realization of a third transmit toggling approach.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

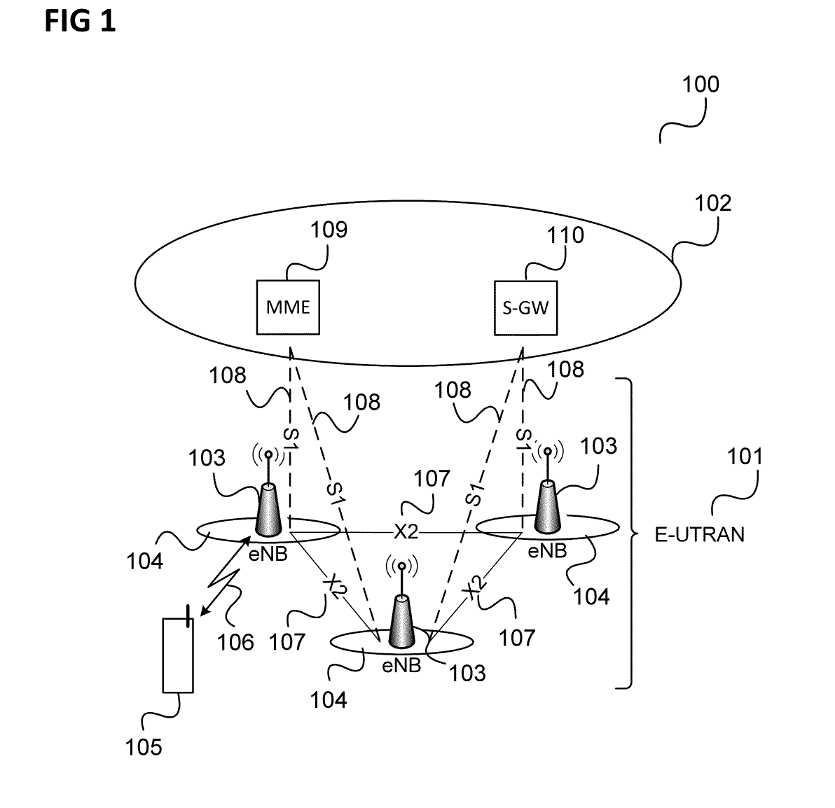

FIG. 1 shows a communication system 100.

The communication system 100 may be a cellular mobile communication system (also referred to as cellular radio communication network in the following) including a radio access network (e.g. an UTRAN (UMTS (Universal Mobile Communications System) Terrestrial Radio Access Network) according to UMTS, or an E-UTRAN (Evolved UMTS Terrestrial Radio Access Network) according to LTE (Long Term Evolution), or LTE-Advanced) 101 and a core network (e.g. an EPC, Evolved Packet Core, according LTE, or LTE-Advanced) 102. The radio access network 101 may include base stations (e.g. base transceiver stations or home base stations such as NodeBs, NBs according to UMTS or eNodeBs, eNBs, Home eNodeBs, HeNBs according to LTE, or LTE-Advanced) 103. Each base station 103 may provide radio coverage for one or more mobile radio cells 104 of the radio access network 101. In other words: The base stations 103 of the radio access network 101 may span different types of cells 104 (e.g. macro cells, femto cells, pico cells, small cells, open cells, closed subscriber group cells, hybrid cells, for instance according to LTE, or LTE-Advanced). It should be noted that examples described in the following may also be applied to other communication networks than LTE communication networks, e.g. communication networks according to UMTS, GSM (Global System for Mobile Communications) etc.

A mobile terminal (e.g. UE) 105 located in a mobile radio cell 104 may communicate with the core network 102 and with other mobile terminals 105 via the base station 103 providing coverage in (in other words operating) the mobile radio cell 104. In other words, the base station 103 operating the mobile radio cell 104 in which the mobile terminal 105 is located may provide the E-UTRA user plane terminations including the PDCP (Packet Data Convergence Protocol) layer, the RLC (Radio Link Control) layer and the MAC (Medium Access Control) layer and control plane terminations including the RRC (Radio Resource Control) layer towards the mobile terminal 105.

Control and user data may be transmitted between a base station 103 and a mobile terminal 105 located in the mobile radio cell 104 operated by the base station 103 over the air interface 106 on the basis of a multiple access method. On the LTE air interface 106 different duplex methods, such as FDD (Frequency Division Duplex) or TDD (Time Division Duplex), may be deployed.

The base stations 103 are interconnected with each other by means of a first interface 107, e.g. an X2 interface. The base stations 103 are also connected by means of a second interface 108, e.g. an S1 interface, to the core network 102, e.g. to an MME (Mobility Management Entity) 109 via an S1-MME interface 108 and to a Serving Gateway (S-GW) 110 by means of an S1-U interface 108. The S1 interface 108 supports a many-to-many relation between MMEs/S-GWs 109, 110 and the base stations 103, i.e. a base station 103 may be connected to more than one MME/S-GW 109, 110 and an MME/S-GW 109, 110 may be connected to more than one base station 103. This may enable network sharing in LTE.

For example, the MME 109 may be responsible for controlling the mobility of mobile terminals located in the coverage area of E-UTRAN, while the S-GW 110 may be responsible for handling the transmission of user data between mobile terminals 105 and the core network 102.

In case of LTE, the radio access network 101, i.e. the E-UTRAN 101 in case of LTE, may be seen to consist of the base station 103, i.e. the eNBs 103 in case of LTE, providing the E-UTRA user plane (PDCP/RLC/MAC) and control plane (RRC) protocol terminations towards the UE 105.

Each base station 103 of the communication system 100 may control communications within its geographic coverage area, namely its mobile radio cell 104 that is ideally represented by a hexagonal shape. When the mobile terminal 105 is located within a mobile radio cell 104 and is camping on the mobile radio cell 104 (in other words is registered with a Tracking Area (TA) assigned to the mobile radio cell 104) it communicates with the base station 103 controlling that mobile radio cell 104. When a call is initiated by the user of the mobile terminal 105 (mobile originated call) or a call is addressed to the mobile terminal 105 (mobile terminated call), radio channels are set up between the mobile terminal 105 and the base station 103 controlling the mobile radio cell 104 in which the mobile station is located. If the mobile terminal 105 moves away from the original mobile radio cell 104 in which a call was set up and the signal strength of the radio channels established in the original mobile radio cell 104 weakens, the communication system may initiate a transfer of the call to radio channels of another mobile radio cell 104 into which the mobile terminal 105 moves.

In practice, a plurality of communication networks including a radio access network 101 and a core network 102 as described above are provided by different operators such that the coverage areas of the communication networks overlap, i.e. a mobile terminal may be located within a radio cell 104 operated by a base station 103 belonging to a first communication network of a first operator and at the same time be located within a radio cell 104 operated by a base station 103 belonging to a second communication network of a second operator.

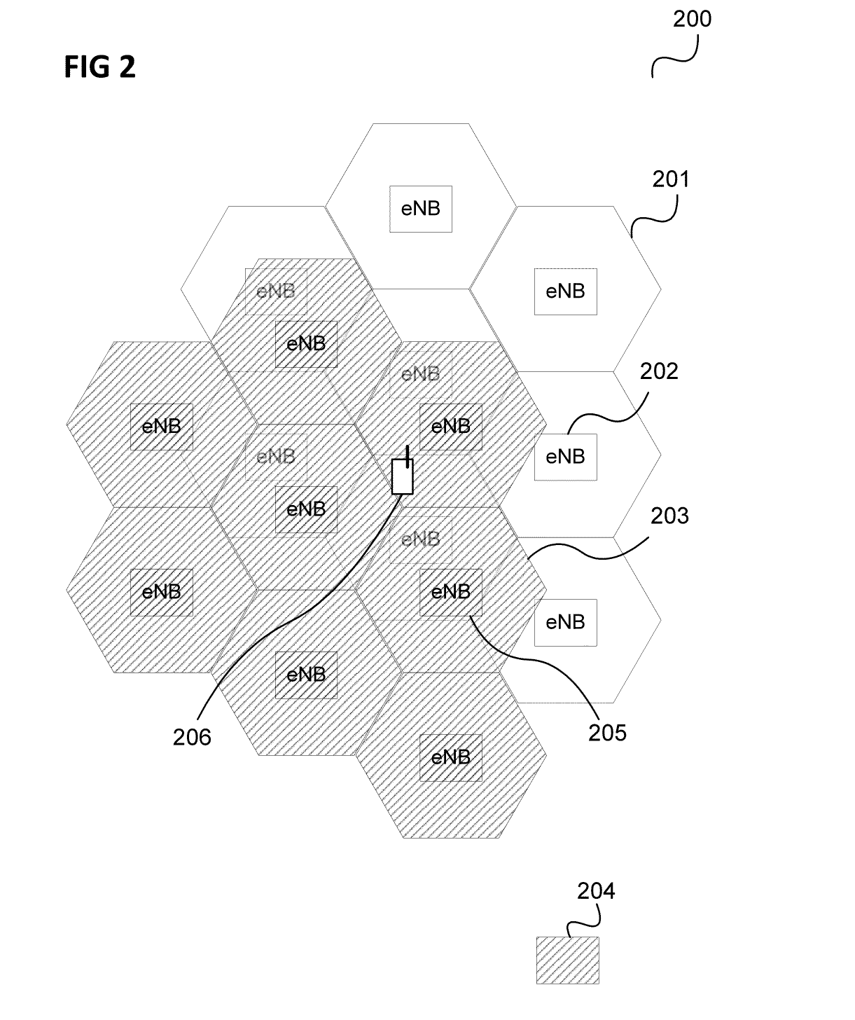

This is illustrated in FIG. 2.

FIG. 2 shows a radio cell arrangement 200.

The radio cell arrangement 200 includes a first plurality of radio cells 201 (shown without hatching) operated by a plurality of first base stations 202 of a first communication network, and a second plurality of radio cells 203 indicated by a hatching 204 operated by a plurality of second base stations 205 of a second communication network. Although all base stations 205 are indicated as eNBs in this example, the first communication network and the second communication network may use the same or different ratio access technologies (RATs) of e.g. LTE, GSM, UMTS etc.

As illustrated, the second plurality of radio cells 203 overlaps the first plurality of radio cells 204 such that a mobile terminal 206 located in the overlapping area may connect to both the first communication network and the second communication network, e.g. may both register with a base station 202 of the first communication network and a base station 205 of the second communication network.

For being able to use both the first communication network and the second communication network as home networks (and not being forced to roam in case the mobile terminal 206 is located in the coverage area of only one of the communication networks and having only an subscriber identity module of the other communication network), the mobile terminal 206 may be a Multi-SIM device, i.e. may include two (or even more) subscriber identity modules (SIMs). It should be noted that the usage of two SIMs (e.g. SIM cards) to avoid roaming costs is only an example of the many use cases for Multi-SIM (of which further ones are given below).

The market for Multi-SIM devices is growing, especially in many Asian and south American regions. Customers take advantage of different operators' offers, e.g. for cheap voice and data services, to optimize roaming costs when travelling and using a second SIM card of a local operator at a roaming location of a first SIM card's operator, or just to separate private and business communication.

Multi-SIM offers a variety of operation modes. Considering two SIM cards two main levels of differentiation are Dual-SIM Dual Active (DSDA) and Dual-SIM Dual Standby (DSDS). DSDA requires two full modems, one for each SIM card, with receive and transmit capability operating simultaneously for independent services, e.g. one for voice and one for data.

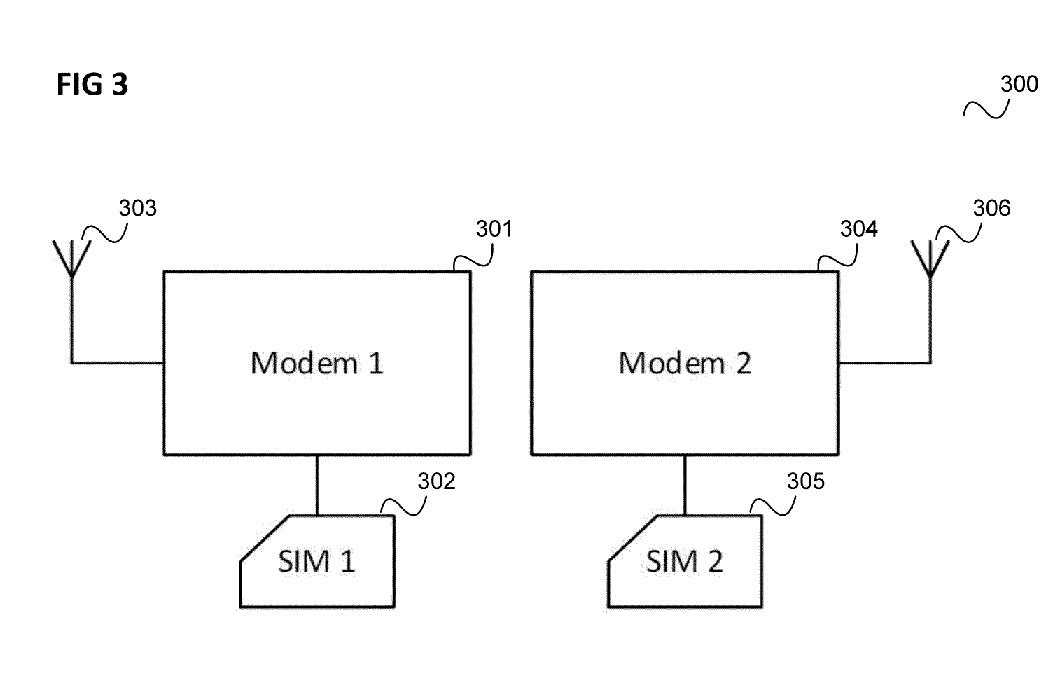

FIG. 3 shows the high level architecture of a communication terminal for a DSDA system.

The communication terminal comprises a first modem 301 which serves a first SIM 302 by means of a first antenna 303 and a second modem 304 which serves a first SIM 305 by means of a second antenna 306.

A special case is the LTE network in a specific geographical location, such as China. In general LTE networks do not provide circuit switched speech services. Instead speech services are either realized via circuit-switched fallback (CSFB, i.e. fallback to 2G or 3G CS for all mobile originated and mobile terminated speech calls) or as voice-over-IP (IMS) calls over a packet switched LTE connection (VoLTE). However, certain operators do not rely on those standardized LTE voice services and have defined their own, proprietary voice solution. The Chinese operator has introduced an operation mode where the UE is circuit-switched attached to 2G (GSM) and in parallel packet-switched attached to LTE. Thus, it is desirable to be simultaneously in standby or even active on up to two RATs with one SIM card. This may be realized with two independent modems and is called Single-SIM Dual Active (SSDA) or Simultaneous GSM and LTE (SGLTE). For DSDA capable devices the Chinese operator requires parallel operation of DSDA and SSDA, which requires even three modems in current solutions.

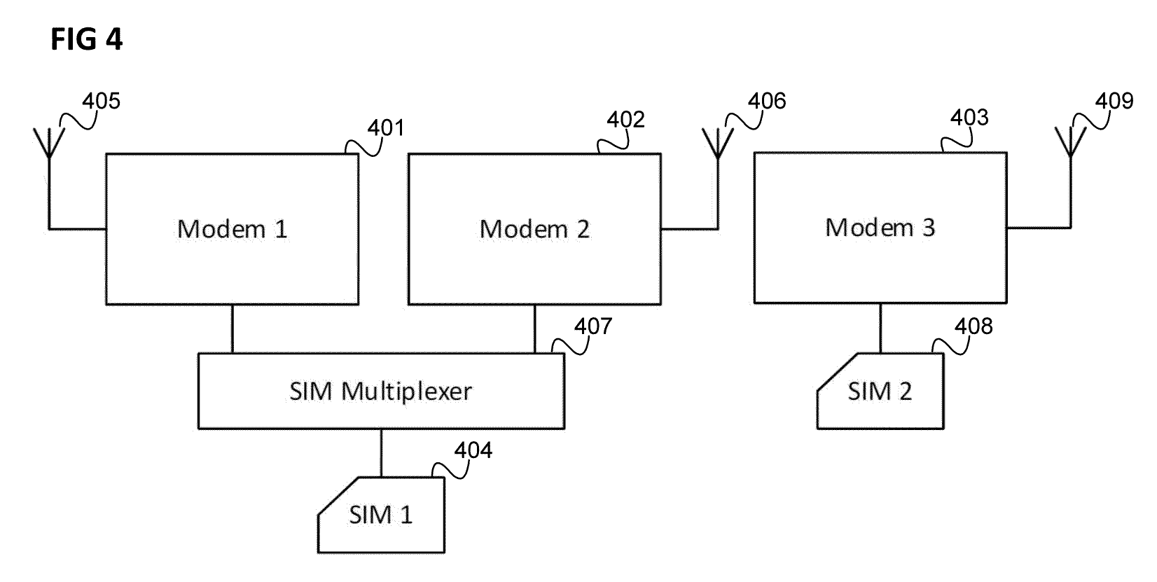

FIG. 4 shows the high level architecture for a communication terminal for a combined SSDA and DSDA system.

The communication terminal comprises a first modem 401, a second modem 402 and a third modem 403. The first modem 401 serves a first SIM 404 by means of a first antenna 405 and the second modem 402 serves the first SIM 404 by means of a second antenna 406, e.g. according to different RATs. The first SIM 404 is coupled to the first modem 401 and the second modem 402 by means of a SIM multiplexer 407. The third modem 403 serves a second SIM 408 by means of a third antenna 409.

The basic meaning of DSDS is that a single modem is shared between two SIM cards, such that both SIMs are in standby/idle mode and can simultaneously receive paging for incoming calls.

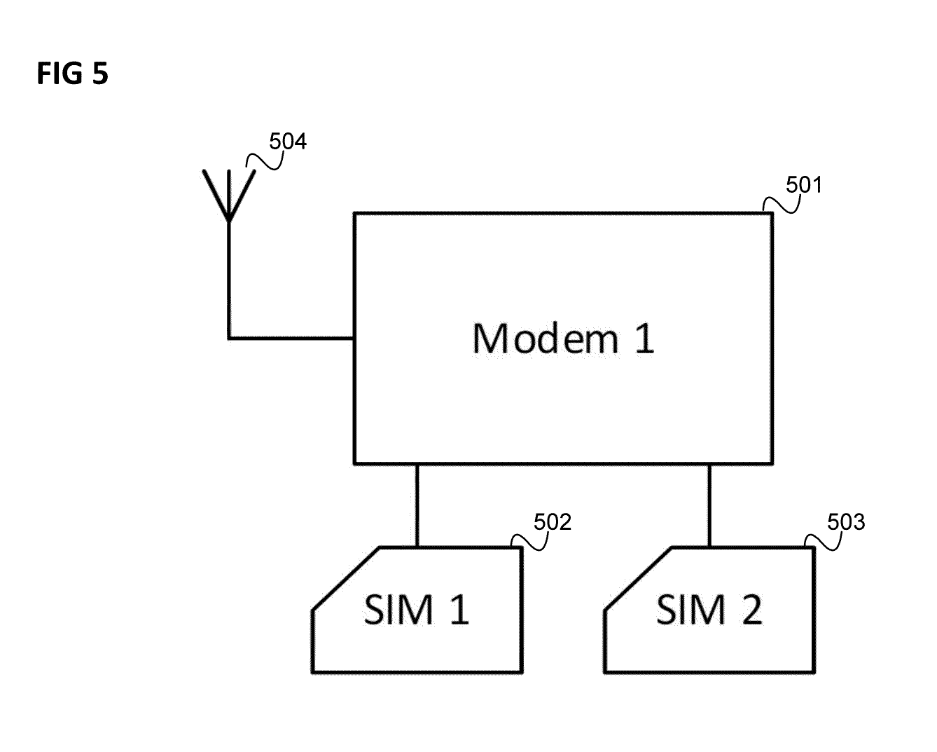

FIG. 5 shows the high level architecture of a communication terminal for a DSDS system.

The communication terminal comprises a modem 501 which serves a first SIM 502 and a second SIM 503 by means of an antenna 504.

Once an incoming call for one of the SIMs 502, 503 is detected in a DSDS system there are various possibilities how to react on the incoming call depending on the type of the call and the status of the other SIM 502, 503 (e.g. standby, in a call, etc.). In case two independent receive paths are present in the modem 501, e.g. due to DL (downlink) Carrier Aggregation support, they can be used in idle mode to receive the paging information of the two SIMs 502, 503 independently. This is called Dual Receive DSDS (DR-DSDS).

DSDS may also use only one receive path to receive the paging information for incoming calls of both SIMs 502, 503 (e.g. of two different RATs). In this case the receive path is shared in an intelligent manner between both SIMs 502, 503. In case one SIM 502, 503 has an active data connection the reception of the paging information of the second SIM 502, 503 may be done by ‘stealing’ the receive path from the first SIM for a certain time to receive the paging information or to carry out measurements necessary to maintain basic idle mode mobility. This behavior is called Data versus Paging (DvP, allows only paging reception on the second SIM) or enhanced Data versus Paging (eDvP, allows full idle mode mobility, that is possible without sending data, on the second SIM). Both SIMs may also be in idle mode at the same time with only one receive path.

DSDS and DR-DSDS systems, including eDvP, typically have the limitation that as soon as there is an active connection (voice or data) for one SIM, caller information for incoming calls or SMS for the other SIM can no longer be retrieved. Voice calls are not possible for the other SIM either. Reception of paging and limited mobility is still possible, but neither caller ID display nor SMS transmission is possible as this requires a bidirectional signaling connection to the radio access network which cannot be provided when a single transmission (TX) path is occupied by the active connection on the first SIM. A parallel voice call for the second SIM even requires a bidirectional circuit-switched data connection which cannot be provided when a single TX path is occupied by the active connection for the first SIM. These use cases may be addressed by a DSDA approach. However, this has a cost, chip and/or PCB (printed circuit board) area and power penalty due to the two complete modems (i.e. dual baseband plus dual RF transceiver plus dual RF frontend including power amplifiers etc.) required.

In the following, an approach is described which allows addressing these and other use cases in a more efficient manner.

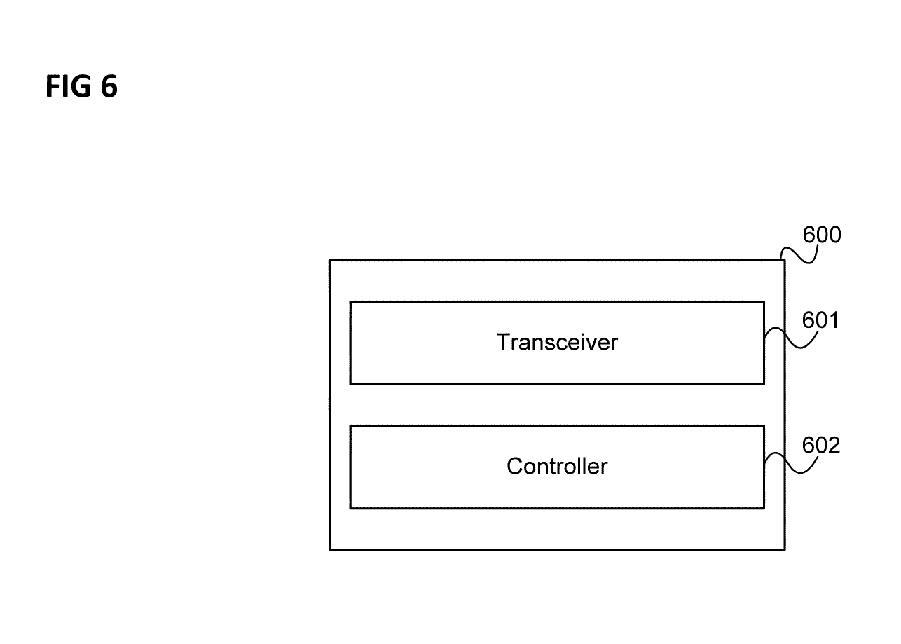

FIG. 6 shows a communication terminal 600.

The communication terminal 600 (e.g. a mobile device such as a mobile phone) comprises a transceiver 601 configured to establish a layer three communication connection and to transmit data via the layer three communication connection.

The communication terminal 600 further comprises a controller 602 configured to control the transceiver to pause data transmission of the layer three communication connection, transmit data via a second communication connection during the pausing of the data transmission of the layer three communication connection and resume transmission of data via the layer three communication connection after the transmission of data via the second communication connection is completed.

In other words, a transmit path is shared between a first connection and a second connection by interrupting the transmission on the first connection but keeping the first connection established for the time of the interruption (i.e. keeping the layer three connection, e.g. staying in RRC (Radio Resource Control) connected state for the first connection).

It should be noted that during pausing of transmission via the layer three communication connection reception via the layer three communication connection may resume. For example, the communication terminal (e.g. the transceiver) comprises two receivers (e.g. RX units) wherein one serves the first connection and the second the second connection such that reception can be performed in parallel but comprises only one transmitter (e.g. TX module). It should be noted that since RX parts are typically cheaper than TX parts sharing of TX parts may be considered to be more important or sufficient. Further, two RX paths may also exist anyway due to DL Carrier Aggregation capabilities of the communication terminal.

The data transmitted via the layer three communication connection may for example include voice or speech data but also other types of data such as video data, program code, text data, image data etc.

During the pausing of the data transmission of the layer three communication connection, the communication terminal and the network component to which the connection is established keep the layer three communication connection established. This may for example mean that a context of the layer three communication connection is kept, e.g. a radio network temporary identifier of the communication terminal is kept.

For example, the communication terminal has a single modem but two SIMs and the modem is shared for transmission purposes between the two SIMs, for example in addition and similarly and as the receive path is being shared in a DSDS approach. For example, this allows signaling an incoming call to the user or even answer an incoming call or to receive an SMS (Short Message Service) message on one SIM card while the other SIM card has an active data or voice connection without the need for a second transmit path. Thus at least the caller ID for an incoming call can be signaled to the user or the call can even be accepted while maintaining an active connection on the other SIM.

Similar to eDvP this can be realized by ‘stealing’ the transmit path from the first SIM (or generally the first connection) for certain times to transmit signaling data or user data for the second SIM. This behavior is also referred to as Transmit Toggling (TxT) in the following.

It should be noted that examples described in the following which are based on two SIMs may analogously apply to the case of two RATs (used e.g. with a single SIM). For example, a user experience very similar to parallel DSDA and SSDA as illustrated in FIG. 4 can be achieved with two modems only, by applying TxT on two of them, e.g. to the first modem 401 and the second modem 402.

The components of the communication terminal (e.g. the transceiver and the controller) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

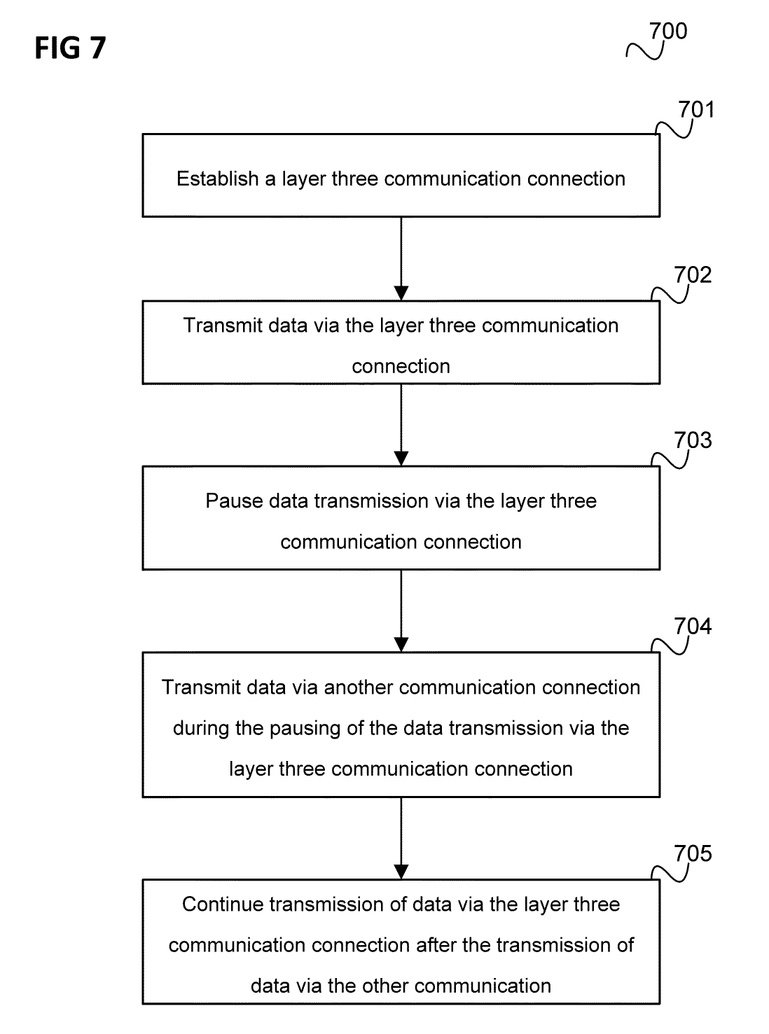

The communication terminal for example carries out a method as illustrated in FIG. 7.

FIG. 7 shows a flow diagram 700 illustrating a method for performing a communication, e.g. carried out by a communication terminal.

In 701, the communication terminal establishes a layer three communication connection.

In 702, the communication terminal transmits data via the layer three communication connection.

In 703, the communication terminal pauses data transmission of the layer three communication connection.

In 704, the communication terminal transmits data via a second communication connection during the pausing of the data transmission of the layer three communication connection.

In 705, the communication terminal resumes transmission of data via the layer three communication connection after the transmission of data via the second communication connection is completed.

The following examples pertain to further embodiments.

Example 1 is a communication terminal as illustrated in FIG. 6.

In Example 2, the subject matter of Examples 1 may optionally include the controller being configured to control the transceiver to establish the second communication connection.

In Example 3, the subject matter of any one of Examples 1-2 may optionally include the second communication connection being a second layer three communication connection.

In Example 4, the subject matter of any one of Examples 1-3 may optionally include the transceiver being configured to transmit the data via the layer three communication connection by means of a first radio access technology and the controller being configured to control the transceiver to transmit the data via the second communication connection during the pausing of the data transmission of the layer three communication connection by means of a second radio access technology different from the first radio access technology.

In Example 5, the subject matter of any one of Examples 1-4 may optionally include a first subscriber identity and a second subscriber identity and the layer three communication connection being a communication connection established using the first subscriber identity and the second communication connection being a communication connection established using the second subscriber identity.

In Example 6, the subject matter of any one of Examples 1-5 may optionally include the controller being configured to control the transceiver to keep the layer three communication connection established during the pausing of the data transmission of the layer three communication connection.

In Example 7, the subject matter of any one of Examples 1-6 may optionally include the transceiver having an idle mode and a connected mode and the controller being configured to control the transceiver to stay in connected mode during the pausing of the data transmission of the layer three communication connection.

In Example 8, the subject matter of any one of Examples 1-7 may optionally include the layer three communication connection being a layer three communication connection to a network component of a radio communication network and the controller being configured to control the transceiver to pause the data transmission of the layer three communication connection to keep the layer three communication connection established by the network component during the pausing of the data transmission of the layer three communication connection.

In Example 9, the subject matter of any one of Examples 1-8 may optionally include the controller being configured to control the transceiver to pause the data transmission of the layer three communication connection for a short period of time to keep the layer three communication connection established by the network component during the pausing of the data transmission of the layer three communication connection.

In Example 10, the subject matter of any one of Examples 1-9 may optionally include the controller being configured to control the transceiver to pause the data transmission of the layer three communication connection to keep a layer three communication connection context for the communication terminal established by the network component during the pausing of the data transmission of the layer three communication connection.

In Example 11, the subject matter of any one of Examples 1-10 may further include the controller being configured to control the transceiver to pause the data transmission of the layer three communication connection for a short period of time to keep a layer three communication connection context for the communication terminal established by the network component during the pausing of the data transmission of the layer three communication connection.

In Example 12, the subject matter of Examples 11 may optionally include the layer three communication connection context including a radio network temporary identifier of the communication terminal.

In Example 13, the subject matter of any one of Examples 1-12 may optionally include the controller being configured to control the transceiver to pause the data transmission of the layer three communication connection and to transmit data via the second communication connection during the pausing of the data transmission of the layer three communication connection by controlling a physical layer transmitter component to switch from the transmission of data for the layer three communication connection to the transmission of data for the second communication connection for the duration of the pausing of the data transmission of the layer three communication connection.

In Example 14, the subject matter of any one of Examples 1-13 may optionally include the transceiver being configured to transmit data via the layer three communication connection in accordance with a frame structure and the controller being configured to control the transceiver to pause the data transmission of the layer three communication connection by omitting the transmission of data for complete frames, sub-frames, timeslots or symbols of the frame structure.

In Example 15, the subject matter of any one of Examples 1-14 may optionally include the controller being configured to control the transceiver to pause the data transmission of the layer three communication connection by ignoring uplink transmission grants for data transmission of the layer three communication connection.

In Example 16, the subject matter of any one of Examples 1-15 may optionally include controlling the transceiver to pause the data transmission of the layer three communication connection comprising leaving spectral communication resources allocated for data transmission of the layer three communication connection unused for data transmission of the layer three communication connection.

In Example 17, the subject matter of any one of Examples 1-16 may optionally include controlling the transceiver to pause the data transmission of the layer three communication connection comprising deterring a resource allocation network component from assigning spectral communication resources for transmission via the layer three communication connection to the communication terminal.

In Example 18, the subject matter of any one of Examples 1-17 may optionally include the communication terminal being a mobile device and the layer three communication connection being a communication connection for a voice or data call.

In Example 19, the subject matter of any one of Examples 1-18 may optionally include the second communication connection being a signaling connection.

In Example 20, the subject matter of any one of Examples 1-19 may optionally include the communication terminal being a mobile device and the second communication connection being a signaling connection for receiving data about a caller which has initiated a call to the communication terminal during the layer three communication connection.

In Example 21, the subject matter of any one of Examples 1-20 may optionally include the communication terminal being a mobile device and the second communication connection being a signaling connection for receiving a text message or transmitting a text message.

In Example 22, the subject matter of any one of Examples 1-21 may optionally include the controller being configured to control the transceiver to resume data reception via the layer three communication connection during the pausing of the data transmission of the layer three communication connection.

In Example 23, the subject matter of any one of Examples 1-22 may optionally include the data transmission of the layer three communication connection and the transmission via the second communication connection being uplink data transmissions to a base station of a cellular mobile communication network.

Example 24 is a method for performing a communication as illustrated in FIG. 7.

In Example 25, the subject matter of Examples 24 may optionally include establishing the second communication connection.

In Example 26, the subject matter of any one of Examples 24-25 may optionally include the second communication connection being a second layer three communication connection.

In Example 27, the subject matter of any one of Examples 24-26 may optionally include transmitting the data via the layer three communication connection by means of a first radio access technology and transmitting the data via the second communication connection during the pausing of the data transmission of the layer three communication connection by means of a second radio access technology different from the first radio access technology.

In Example 28, the subject matter of any one of Examples 24-29 may optionally include the layer three communication connection being a communication connection established using a first subscriber identity and the second communication connection being a communication connection established using a second subscriber identity.

In Example 29, the subject matter of any one of Examples 24-28 may optionally include keeping the layer three communication connection established during the pausing of the data transmission of the layer three communication connection.

In Example 30, the subject matter of any one of Examples 24-29 may optionally include staying in connected mode during the pausing of the data transmission of the layer three communication connection.

In Example 31, the subject matter of any one of Examples 24-30 may optionally include the layer three communication connection being a layer three communication connection to a network component of a radio communication network and the method comprising pausing the data transmission of the layer three communication connection to keep the layer three communication connection established by the network component during the pausing of the data transmission of the layer three communication connection.

In Example 32, the subject matter of any one of Examples 24-31 may optionally include pausing the data transmission of the layer three communication connection for a short period of time to keep the layer three communication connection established by the network component during the pausing of the data transmission of the layer three communication connection.

In Example 33, the subject matter of any one of Examples 24-32 may optionally include pausing the data transmission of the layer three communication connection to keep a layer three communication connection context for the communication terminal established by the network component during the pausing of the data transmission of the layer three communication connection.

In Example 34, the subject matter of any one of Examples 24-33 may optionally include pausing the data transmission of the layer three communication connection for a short period of time to keep a layer three communication connection context for the communication terminal established by the network component during the pausing of the data transmission of the layer three communication connection.

In Example 35, the subject matter of Example 34 may optionally include the layer three communication connection context including a radio network temporary identifier of the communication terminal.

In Example 36, the subject matter of any one of Examples 24-35 may optionally include pausing the data transmission of the layer three communication connection and transmitting data via the second communication connection during the pausing of the data transmission of the layer three communication connection by controlling a physical layer transmitter component to switch from the transmission of data for the layer three communication connection to the transmission of data for the second communication connection for the duration of the pausing of the data transmission of the layer three communication connection.

In Example 37, the subject matter of any one of Examples 24-36 may optionally include transmitting data via the layer three communication connection in accordance with a frame structure and pausing the data transmission of the layer three communication connection by omitting the transmission of data for complete frames, sub-frames, timeslots or symbols of the frame structure.

In Example 38, the subject matter of any one of Examples 24-37 may optionally include pausing the data transmission of the layer three communication connection by ignoring uplink transmission grants for data transmission of the layer three communication connection.

In Example 39, the subject matter of any one of Examples 24-38 may optionally include pausing the data transmission of the layer three communication connection comprising leaving spectral communication resources allocated for data transmission of the layer three communication connection unused for data transmission of the layer three communication connection.

In Example 40, the subject matter of any one of Examples 24-39 may optionally include pausing the data transmission of the layer three communication connection comprising deterring a resource allocation network component from assigning spectral communication resources for transmission via the layer three communication connection to the method.

In Example 41, the subject matter of any one of Examples 24-40 may optionally include the layer three communication connection being a communication connection of a mobile device for a voice or data call.

In Example 42, the subject matter of any one of Examples 24-41 may optionally include the second communication connection being a signaling connection.

In Example 43, the subject matter of any one of Examples 24-42 may optionally include the second communication connection being a signaling connection of a mobile device for receiving data about a caller which has initiated a call to the mobile device during the layer three communication connection.

In Example 44, the subject matter of any one of Examples 24-43 may optionally include the second communication connection being a signaling connection of a mobile device for receiving a text message or transmitting a text message.

In Example 45, the subject matter of any one of Examples 24-44 may optionally include continuing data reception via the layer three communication connection during the pausing of the data transmission of the layer three communication connection.

In Example 46, the subject matter of any one of Examples 24-45 may optionally include the data transmission of the layer three communication connection and the transmission via the second communication connection being uplink data transmissions to a base station of a cellular mobile communication network.

Example 47, is a computer readable medium having recorded instructions thereon which, when executed by a processor, make the processor perform a method for controlling a data transmission according to any one of Examples 24 to 46.

Example 48 is a communication terminal comprising a transceiving means for establishing a layer three communication connection and to transmit data via the layer three communication connection and a controlling means for controlling the transceiving means to pause data transmission of the layer three communication connection, transmit data via a second communication connection during the pausing of the data transmission of the layer three communication connection and resume transmission of data via the layer three communication connection after the transmission of data via the second communication connection is completed.

In Example 49, the subject matter of Example 48 may optionally include the controlling means being for controlling the transceiving means to establish the second communication connection.

In Example 50, the subject matter of any one of Examples 48-49 may optionally include the second communication connection being a second layer three communication connection.

In Example 51, the subject matter of any one of Examples 48-50 may optionally include the transceiving means being for transmitting the data via the layer three communication connection by means of a first radio access technology and the controlling means being for controlling the transceiving means to transmit the data via the second communication connection during the pausing of the data transmission of the layer three communication connection by means of a second radio access technology different from the first radio access technology.

In Example 52, the subject matter of any one of Examples 48-51 may optionally include a first subscriber identity and a second subscriber identity and the layer three communication connection being a communication connection established using the first subscriber identity and the second communication connection being a communication connection established using the second subscriber identity.

In Example 53, the subject matter of any one of Examples 48-52 may optionally include the controlling means being for controlling the transceiving means to keep the layer three communication connection established during the pausing of the data transmission of the layer three communication connection.

In Example 54, the subject matter of any one of Examples 48-53 may optionally include the transceiving means having an idle mode and a connected mode and the controlling means being for controlling the transceiving means to stay in connected mode during the pausing of the data transmission of the layer three communication connection.

In Example 55, the subject matter of any one of Examples 48-54 may optionally include the layer three communication connection being a layer three communication connection to a network component of a radio communication network and the controlling means being for controlling the transceiving means to pause the data transmission of the layer three communication connection to keep the layer three communication connection established by the network component during the pausing of the data transmission of the layer three communication connection.

In Example 56, the subject matter of any one of Examples 48-57 may optionally include the controlling means being for controlling the transceiving means to pause the data transmission of the layer three communication connection for a short period of time to keep the layer three communication connection established by the network component during the pausing of the data transmission of the layer three communication connection.

In Example 57, the subject matter of any one of Examples 48-56 may optionally include the controlling means being for controlling the transceiving means to pause the data transmission of the layer three communication connection to keep a layer three communication connection context for the communication terminal established by the network component during the pausing of the data transmission of the layer three communication connection.

In Example 58, the subject matter of any one of Examples 48-57 may optionally include the controlling means being for controlling the transceiving means to pause the data transmission of the layer three communication connection for a short period of time to keep a layer three communication connection context for the communication terminal established by the network component during the pausing of the data transmission of the layer three communication connection.

In Example 59, the subject matter of Example 58 may optionally include the layer three communication connection context including a radio network temporary identifier of the communication terminal.

In Example 60, the subject matter of any one of Examples 48-59 may optionally include the controlling means being for controlling the transceiving means to pause the data transmission of the layer three communication connection and to transmit data via the second communication connection during the pausing of the data transmission of the layer three communication connection by controlling a physical layer transmitter component to switch from the transmission of data for the layer three communication connection to the transmission of data for the second communication connection for the duration of the pausing of the data transmission of the layer three communication connection.

In Example 61, the subject matter of any one of Examples 48-60 may optionally include the transceiving means being for transmitting data via the layer three communication connection in accordance with a frame structure and the controlling means being for controlling the transceiving means to pause the data transmission of the layer three communication connection by omitting the transmission of data for complete frames, sub-frames, timeslots or symbols of the frame structure.

In Example 62, the subject matter of any one of Examples 48-61 may optionally include the controlling means being for controlling the transceiving means to pause the data transmission of the layer three communication connection by ignoring uplink transmission grants for data transmission of the layer three communication connection.

In Example 63, the subject matter of any one of Examples 48-62 may optionally include controlling the transceiving means to pause the data transmission of the layer three communication connection comprising leaving spectral communication resources allocated for data transmission of the layer three communication connection unused for data transmission of the layer three communication connection.

In Example 64, the subject matter of any one of Examples 48-63 may optionally include controlling the transceiving means to pause the data transmission of the layer three communication connection comprising deterring a resource allocation network component from assigning spectral communication resources for transmission via the layer three communication connection to the communication terminal.

In Example 65, the subject matter of any one of Examples 48-46 may optionally include the communication terminal being a mobile device and the layer three communication connection being a communication connection for a voice or data call.

In Example 66, the subject matter of any one of Examples 48-65 may optionally include the second communication connection being a signaling connection.

In Example 67, the subject matter of any one of Examples 48-66 may optionally include the communication terminal being a mobile device and and the second communication connection being a signaling connection for receiving data about a caller which has initiated a call to the communication terminal during the layer three communication connection.

In Example 68, the subject matter of any one of Examples 48-67 may optionally include the communication terminal being a mobile device and the second communication connection being a signaling connection for receiving a text message or transmitting a text message.

In Example 69, the subject matter of any one of Examples 48-68 may optionally include the controlling means being for controlling the transceiving means to resume data reception via the layer three communication connection during the pausing of the data transmission of the layer three communication connection.

In Example 70, the subject matter of any one of Examples 48-69 may optionally include the data transmission of the layer three communication connection and the transmission via the second communication connection being uplink data transmissions to a base station of a cellular mobile communication network.

It should be noted that one or more of the features of any of the examples above may be combined with any one of the other examples.

In the following, examples are described in more detail.

The approach described above with reference to FIG. 5 may for example be used to enable the reception of caller ID, SMS, or voice calls on a second SIM or RAT or also sending an SMS using the second SIM or RAT while there is an active connection on a first SIM or RAT on a single modem via sharing an uplink transmit path between two RATs/SIMs in the time domain (referred to as Transmit Toggling (TxT)). TxT means that communication via the active connection on the first SIM or RAT is interrupted for a short period of time. The shorter the interruption, the less the impact is on the communication. If the interruption is sufficiently short, the impact on the communication is acceptable, e.g. because it can be compensated by error correction or because it is at most barely noticeable by the user.

For example, it may be used to address the following Multi-SIM use cases:
1. Display caller ID for incoming call on one SIM during active connection on other SIM for signaling of missed calls only.
   For this use case an already active voice or data connection on one SIM is assumed. At some point in time the network sends paging on the other SIM to signal an incoming voice call. Since the paging does not contain any information regarding the caller ID, a signaling connection needs to be established in downlink and uplink to be able to transfer and display the caller ID to the user. This connection needs to last only for a short time, just long enough to transfer the caller ID for the second SIM and display it to the user as a missed call. This at least informs the user that there was a missed call on the second SIM and gives him the choice to call back as soon as the activity on the first SIM (voice call or data connection e.g. for video streaming) is finished—which is only possible if the caller ID is known.
2. Display caller ID for incoming call on one SIM during active connection on other SIM and let the user decide which activity to continue.
   This use case is similar to case 1 above with respect to allowing the user to see who is calling on the second SIM while there is an ongoing activity (voice call or data connection) on the first SIM. The difference is that the incoming call on the second SIM is not only displayed as missed call, but instead the caller ID is displayed immediately along with the notification for the incoming call while the connection on the first SIM is still ongoing. Thus the user can now decide whether to end the ongoing activity on the first SIM (e.g. voice or video call, video streaming, chat, online game, etc.) and accept the incoming call on the second SIM or to ignore the incoming call on the second SIM and just continue the ongoing activity on the first SIM. In this case the uplink and downlink activity for the signaling connection on the second SIM card needs to be continued in parallel to the ongoing connection on the first SIM until the user decides which activity to continue. The user might even switch back and forth between the two calls, with one call being active and the other being on hold.
3. SMS reception or SIM transmission on one SIM during active connection on other SIM
   This use case is similar to use case 1 above with respect to allow setup of a signaling connection on the second SIM while an active connection is ongoing on the first SIM. The purpose of the signaling connection here however is to allow reception of an incoming SMS or transmission of an outgoing SMS on the second SIM during an ongoing activity (voice call or data connection) on the first SIM. So the time where both SIM cards need to have simultaneous activity in up- and downlink needs at least to be as long as it takes to receive the SMS message on the second SIM. Core of the use case is to allow reception of an incoming SMS or transmission of an outgoing SMS on the second SIM during an ongoing activity on the first SIM (e.g. voice or video call, video streaming, chat, online game, etc.).
4. Active voice call on one SIM during active data connection on other SIM.
   This use case is similar to use case 2 above with respect to allowing setup of a signaling connection on the second SIM while an active connection is already ongoing on the first SIM. The main difference is that the connection on the second SIM is not limited to signaling only, but that even an active voice call can be supported (i.e. the user can accept an incoming call or setup a mobile originated call). The other difference is that the connection on the first SIM is restricted to be a packet switched data connection.
5. Combination of SSDA with a second SIM from another operator
   For SSDA two independent modems may be deployed which are simultaneously attached to a GSM radio access network and a LTE radio access network, respectively, using only one (CMCC) SIM. If SSDA is enabled in a UE with two SIM slots (e.g. Dual-SIM phone) a third RAT needs to be monitored for the second SIM of the other operator. The specific use case assumes an ongoing voice and data connection on the first SIM, which fully occupies the two available modems for SSDA. Now again an incoming voice call or SMS on the other SIM shall be signaled to the user similar to the use cases 1 to 4 above.

Use cases 1 to 4 may be implemented using DSDA as illustrated in FIG. 3 but at increased costs as mentioned above. Instead, they may be addressed by means of a DSDS system architecture as illustrated in FIG. 4 and the approach described with reference to FIG. 6 (e.g. TxT) as will be described further below.

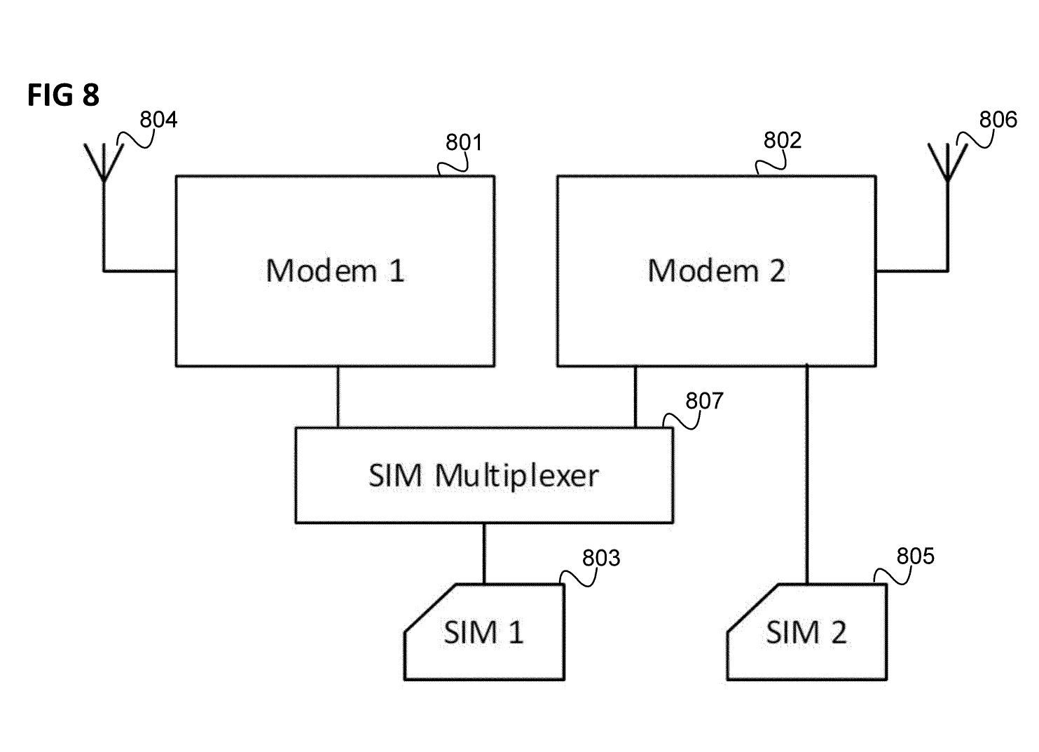

Use case 5 may be addressed by adding even a third modem for the second SIM as illustrated in FIG. 4. However, this increases the cost of the communication terminal accordingly. Instead, use case 5 may be addressed by the approach described with reference to FIG. 6 (e.g. TxT) and a terminal architecture as illustrated in FIG. 8.

FIG. 8 shows a high level architecture of a communication terminal for a combined SSDA plus DSDA light with TxT system.

The communication terminal comprises a first modem 801 and a second modem 802. The first modem 801 serves a first SIM 803 by means of a first antenna 804. The second modem 802 serves both the first SIM 803 as well as a second SIM 805 by means of a second antenna 806. The first SIM 803 is coupled to the modems 801, 802 by means of a SIM multiplexer 807.

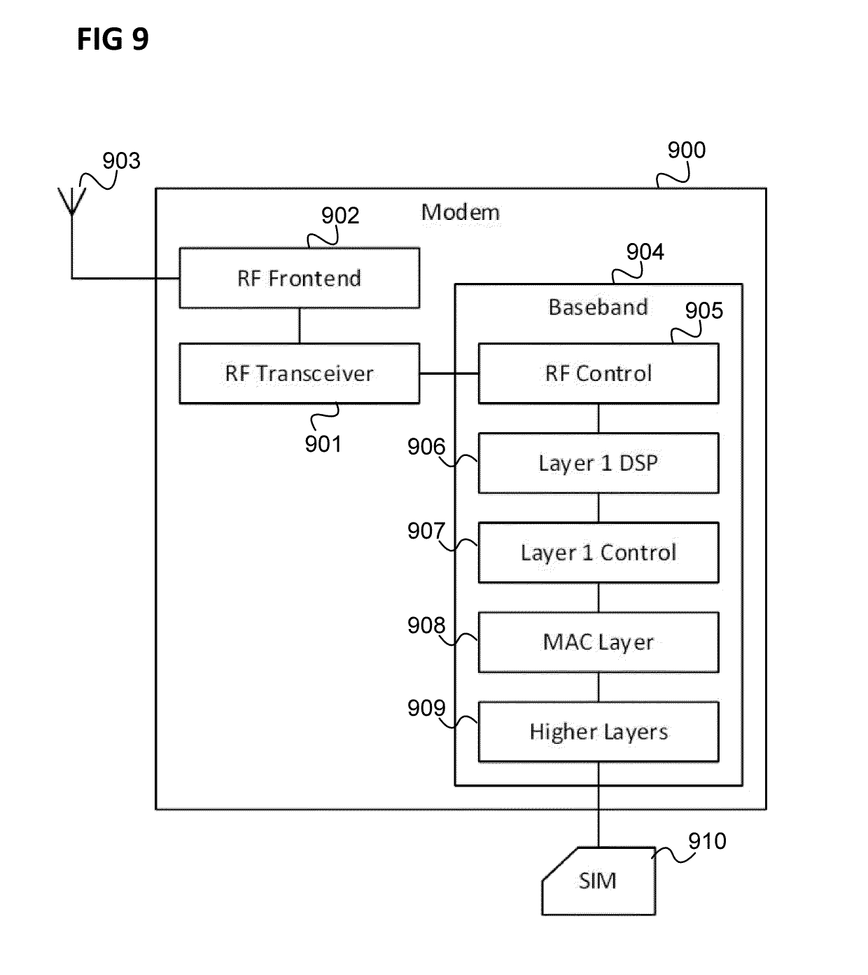

FIG. 9 shows an example of an architecture of a modem 900.

The modem 900 comprises an RF transceiver 901 which is coupled via an RF frontend 902 of the modem 900 with an antenna 903, e.g. of the communication terminal containing the modem 900. The modem further comprises a baseband processor 904. The baseband processor 904 comprises an RF controller 905 (e.g. including one or more controlling components) coupled to the RF transceiver 901 and to a layer one DSP (digital signal processor) 906 (e.g. including one or more DSP processing components). The DSP 906 is coupled to a layer one controller 907 (e.g. including one or more controlling components) which is coupled to a MAC layer block 908 (implementing one or more MAC layer components) which is coupled to a higher layer block 909 (implementing one or more higher layer (i.e. layer three and above) components). The baseband processor 904 is coupled to a SIM 910, e.g. of a communication terminal containing the modem 900 via the higher layer block 909.

The above use cases 1 to 5 may for example be addressed using TxT in the following manner:
1. Display caller ID for incoming call on one SIM during active connection on other SIM with only a single modem.
   The DSDS or DR-DSDS may be combined with TxT method, i.e. to temporarily steal the transmit path from the first SIM and give it to the second SIM in order to react on the paging and answer it via transmit activity to establish a signaling connection. This connection needs to last only for a short time, just long enough to transfer the caller ID for the second SIM and display it to the user as a missed call. This at least informs the user that there was a missed call on the second SIM and gives him the choice to call back as soon as the activity on the first SIM (voice call or data connection e.g. for video streaming) is finished—which is only possible if the caller ID is known.
2. Display caller ID for incoming call on one SIM during active connection on other SIM and let the user decide which activity to continue with only a single modem.
   The DSDS or DR-DSDS approach may be combined with TxT method to get transmit time of the transmit path from the first SIM in order to react on the paging and answer it via transmit activity from the second SIM—at least for such time to get the calling ID for the second SIM and wait for the user's decision whether the incoming call is accepted or not. An extension of this use case may give the user the possibility to toggle between the two calls, always having one call active and the other on hold. Due to the DTX feature the call on hold will need only a signaling connection, so the implementation for the basic and the extended use case are similar.
3. SMS reception or transmission on one SIM during active connection on other SIM with only a single modem.
   The DSDS or DR-DSDS approach can be combined with TxT to get transmit time of the transmit path from the first SIM in order to allow reception of an incoming SMS or a transmission of an SMS on the second SIM during an ongoing activity on the first SIM (e.g. voice or video call, video streaming, chat, online game, etc.).
4. Active voice call on one SIM during active data connection on other SIM with only a single modem.
   The DSDS or DR-DSDS approach can be combined with TxT method to get transmit time of the transmit path from the first SIM in order to react on the paging and answer it via transmit activity from the second SIM until a voice call is setup and as long as the user wants to maintain the active voice call on one SIM and the active data connection on the other SIM.
5. Combination of SSDA with a second SIM from another operator (SSDA+DSDA light w/TxT).
   The SSDA approach can be combined with the (DR-)DSDS approach and TxT in order to share the down- and uplink of the second SIM with one of the two already available Modems/RATs. This sharing may for example be done with the modem running the LTE RAT due to the packet switched nature of LTE which is more suitable for sharing. This allows the user scenarios described in 1 to 4 above in parallel to the SSDA feature without the need for a third modem.

The TxT feature may for example provided using one or a combination of the approaches a) to c) described in the following which are described for a first RAT (LTE in this example), e.g. used by a first SIM and a second RAT (GSM in this example), e.g. used by a second SIM (or, depending on the use case, also used by the first SIM).

a) RF Transceiver Based TxT Using Microscopic Gaps

This approach takes advantage of the low level physical layer radio frequency transmitter to terminate an ongoing transmit activity of the first RAT and instead start the required transmit activity of the second RAT to establish an uplink connection, e.g. in order to get the caller ID or SMS or voice call. The second RAT requires the uplink only for very short time periods, especially to answer the paging and get the information for the caller ID or SMS or uplink slot of a GSM voice call. Directly after such short periods the transmitter is reconfigured to continue the transmit activity of the first RAT. The faster the reconfiguration of the transmitter can be achieved and the shorter the generated gaps are (microscopic gaps) the less the impact on the first RAT.

This approach generates the smallest gaps (compared to approaches b) and c) described below) and thus minimizes the QoS impact on the victim RAT (the RAT which the gaps are stolen from, i.e. the first RAT in this example). It is also the approach with the minimum system impact (compared to approaches b) and c) described below): the arbitration between the two RATs/SIMs is done on RF level and based on antenna timing, thus the BB signal processing and all Layer 1, MAC and higher layer processing is not impacted at all (TX data of the victim RAT inside the generated gap is simply discarded). However, there is additional control complexity inside the RF transceiver and a small power penalty for the PS and baseband processing of TX data which later on is discarded.

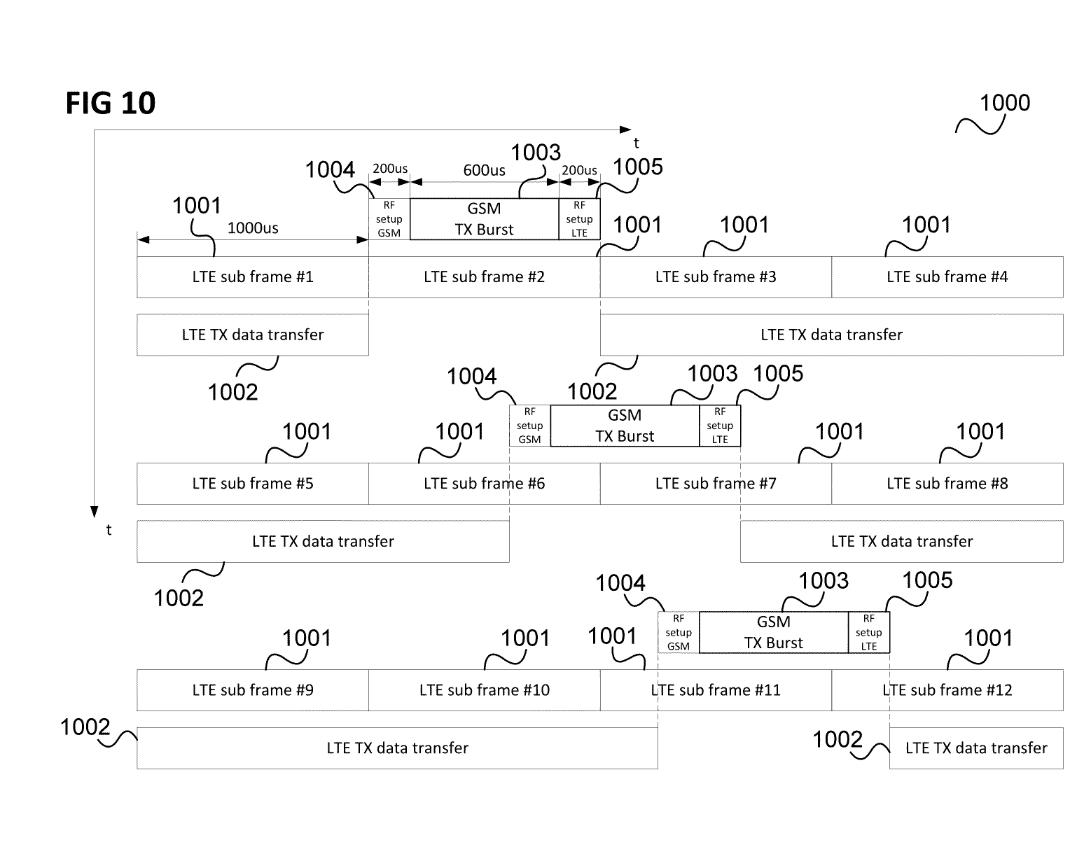

FIG. 10 shows a timing diagram 1000 for a realization of approach a) assuming an ongoing LTE data connection on a first SIM and an incoming 2G voice call on a second SIM.

The timing diagram shows consecutive LTE frames 1001 numbered from 1 to 12 (according to their occurrence in time: time increases from left to right and top to bottom). LTE TX data transfers 1002 that are carried out in the LTE frames 1001 are shown below LTE frames 1001 corresponding to the LTE frames 1001 or parts of the LTE frames 1001 during which they occur. GSM TX bursts 1003 that are carried out during the LTE frames 1001 are shown above LTE frames 1001 corresponding to the LTE frames 1001 or parts of the LTE frames 1001 during which they occur. Each GSM TX burst 1003 is preceded by an interval for the RF transmitter setup to GSM 1004 and followed by an interval for the RF transmitter setup to LTE 1005.

The interruption of the LTE data connection can be minimized by arbitration based on antenna timing within the RF transceiver. In the worst case (assuming TCH26 without DTX for 2G) only 1 LTE sub frame out of 60 gets lost completely while 23 LTE sub frames are only partly transmitted.

It should be noted that the duration of the microscopic gaps may be further shortened by providing two TX paths in the RF transceiver and to switch in the frontend (e.g. shortly before the power amplifier) between these two paths by means of the switch. This increases the system costs but the duration of the gaps may be further shortened because the switching times for the transceiver part (i.e. the intervals 1004, 1005) can be avoided.

b) RF Control Based TxT by Stealing (Sub-)Frames or Slots/Symbols

This approach takes advantage of the capabilities of the RF control unit in the baseband, e.g. RF controller 905. In contrast to approach a) the TxT is not achieved by generating microscopic gaps in the RF path but instead the gaps are generated by omitting the transmission of complete radio (sub-)frames or slots/symbols in the RF control unit of the baseband processor 904. So the transmit path is simply not configured for the transmission of certain (sub-)frames or slots/symbols of the first RAT/SIM and thus is made free for the time-limited transmit activity of the second RAT/SIM. This approach may generate larger gaps than approach a) and thus a stronger impact on the QoS of the victim RAT (first RAT in this case). Still the system impact may be very small as the arbitration between the RATs/SIMs is done at the last baseband processing stage, so all other baseband processing is not impacted and the RF transceiver 901 is not impacted as well. The power penalty for higher layer and baseband processing of data which later on is discarded becomes a bit smaller than for approach a) as the data is discarded earlier in the processing chain (before transmitting to the RF transceiver 901).

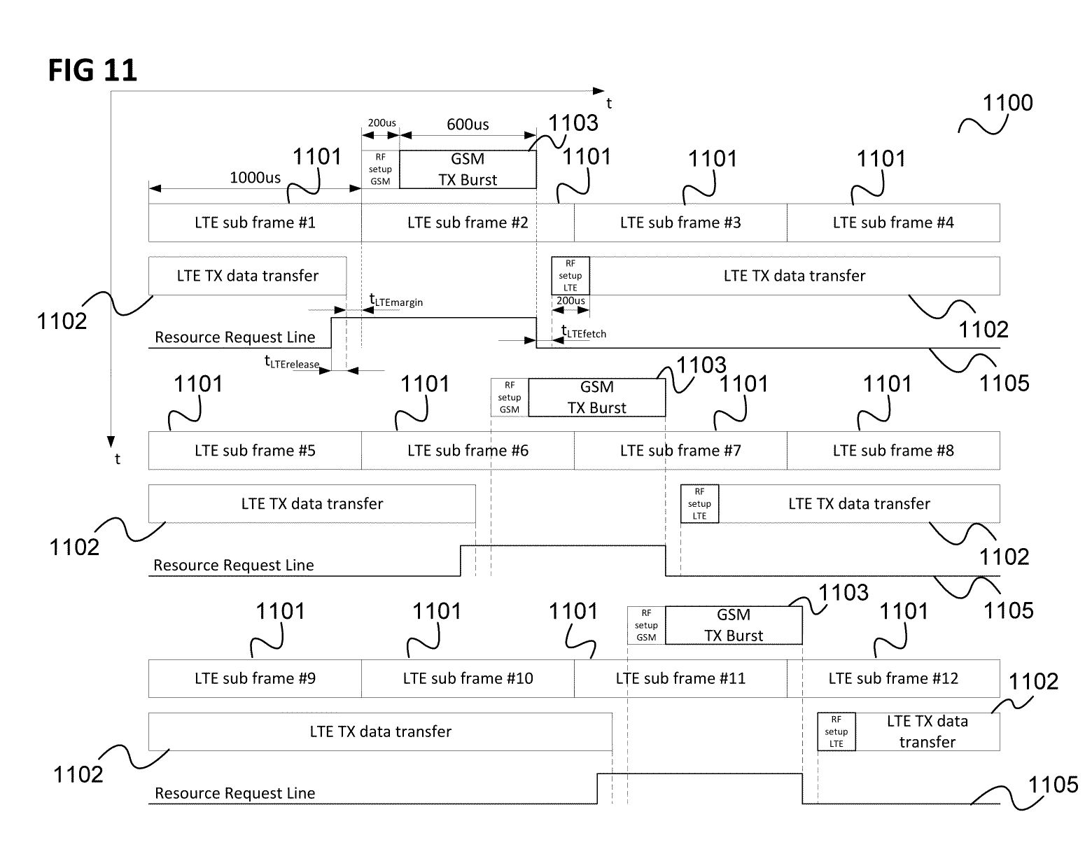

FIG. 11 shows a timing diagram 1100 for a realization of approach b) assuming an ongoing LTE data connection on a first SIM and an incoming 2G voice call on a second SIM.

The timing diagram shows consecutive LTE frames 1101 numbered from 1 to 12 (according to their occurrence in time: time increases from left to right and top to bottom). LTE TX data transfers 1102 that are carried out in the LTE frames 1101 are shown below LTE frames 1101 corresponding to the LTE frames 1101 or parts of the LTE frames 1101 during which they occur. GSM TX bursts 1103 that are carried out during the LTE frames 1101 are shown above LTE frames 1101 corresponding to the LTE frames 1101 or parts of the LTE frames 1101 during which they occur. Each GSM TX burst 1103 is preceded by an interval for the RF transmitter setup to GSM 1004.

Further, the timing diagram shows the state of a (high-active) resource request line 1105 which indicates the timing of the request for communication resources for each GSM TX burst 1103.

It should be noted that the second SIM (using GSM) has to request the required radio gap with some guard time before the GSM operation starts and LTE also loses some time after the GSM resource request has been finished. The impact on the LTE data transfer depends on the times lost before and after the GSM operation. It can be very close to approach a) with only a slight increase of completely omitted LTE sub frames.

c) TxT by Ignoring Uplink Grants

Whereas approaches a) and b) can be seen to steal some time of the transmit activity from the first RAT for the second RAT on RF or on the lowest baseband processing level by simply discarding already processed data of the first RAT, approach c) avoids processing of UL (uplink) data for the first RAT intended for transmission at a time where the TX path is given to the second RAT. This is achieved by ignoring UL grants for (sub-)frames or slots on the first RAT/SIM which would collide with TX activity on the second RAT/SIM. This can be done either on Layer 1 Control or on MAC level. This approach may create larger gaps than a) or b) as one or more entire (sub-)frames or slots are discarded in each TxT cycle (depending on the exact timing relations between the two RATs/SIMs). As a consequence it has a stronger impact on the QoS of the victim RAT. The system impact is higher as precise timing information needs to be exchanged between the first and second SIM/RAT in order to be able to calculate which (sub-)frames or slots will be impacted and thus need to be discarded. Further, the decision about using the TX path for the second RAT/SIM needs to be done on the first RAT/SIM schedule. This may sometimes lead to completely unused TX gaps because the second RAT/SIM may not be able to decide if TX will really be required or not at this time (e.g. DTX detection might not be available 4ms before the TX burst). The benefit is a smaller power penalty as processing of UL data which later on will be discarded anyway is avoided completely.

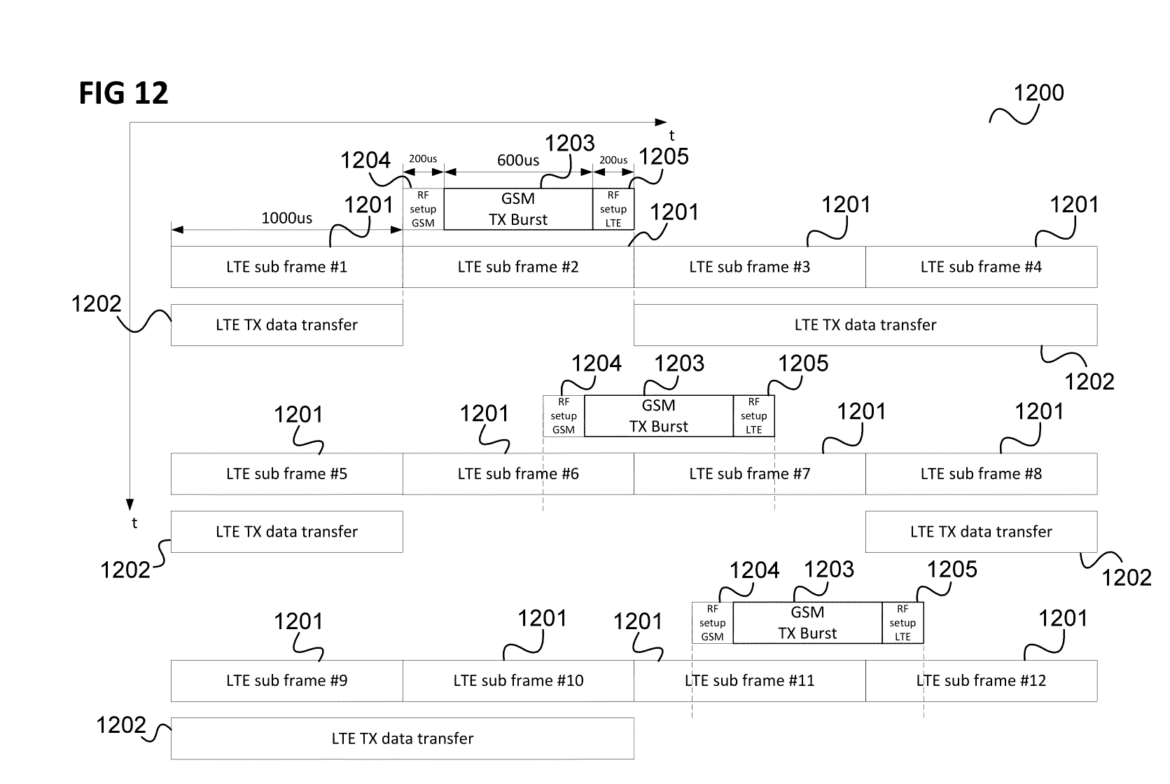

FIG. 12 shows a timing diagram 1200 for a realization of approach c) assuming an ongoing LTE data connection on a first SIM and an incoming 2G voice call on a second SIM.

The timing diagram shows consecutive LTE frames 1201 numbered from 1 to 12 (according to their occurrence in time: time increases from left to right and top to bottom). LTE TX data transfers 1202 that are carried out in the LTE frames 1201 are shown below LTE frames 1201 corresponding to the LTE frames 1201 or parts of the LTE frames 1201 during which they occur. GSM TX bursts 1203 that are carried out during the LTE frames 1201 are shown above LTE frames 1201 corresponding to the LTE frames 1201 or parts of the LTE frames 1201 during which they occur. Each GSM TX burst 1203 is preceded by an interval for the RF transmitter setup to GSM 1204 and followed by an interval for the RF transmitter setup to LTE 1205.

The related Uplink Grant to transmit data within LTE sub frame #N is received on LTE sub frame #(N−4). In the worst case (assuming TCH26 without DTX for 2G) 24 out of 60 LTE sub frames are lost.

The communication terminal may also decide whether to use microscopic gaps as in approach a) or to drop entire subframes as in approach b). For example, if a microscopic gap can be expected to disturb the transmission of a subframe such that the data of the entire subframe is lost (e.g. since the data successfully transmitted is not sufficient for error correction), the communication terminal may decide to use the entire subframe for the transmission of the second SIM/RAT. On the other hand, if only a small gap is needed in a subframe for the second SIM/RAT and it can be expected that the data transmitted in the remaining part of the subframe can be reconstructed, a microscopic gap is generated (in other words approach a) is used).

Further, it may be decided whether a gap is generated within a subframe depending on whether data to be transmitted for the first SIM/RAT is for a retransmission or for an initial transmission (e.g. in a HARQ scheme). For example, gaps in subframes used for retransmissions are allowed but gaps in subframes used for initial transmissions only are forbidden. If for example, a gap is necessary in a subframe but the subframe is for an initial transmission, the subframe may be droppped (unless the gap is small enough such that a successful transmission can be expected).

The dropping of subframes for the transmission for the first SIM/RAT may also be done depending on the data to be transmitted. For example, a sub frame with a gap used for transmission of uplink user data (e.g. LTE PDCCH data) may be dropped while a sub frame with a gap used for transmission of uplink control data (e.g. LTE PUCCH data) is not dropped but the data is transmitted partially.

In addition to approaches a) to c) above, a further approach may be to fake uplink buffer reports in order to avoid being granted uplink resources in advance. For example, the communication terminal requests uplink resources (by signaling an uplink buffer report indicating that its uplink buffer is full) only just before of a needed gap anticipating the typical delay until uplink resources are actually allocated.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A communication terminal comprising
a transceiver configured to establish a layer three communication connection and to transmit data via the layer three communication connection; and
a controller configured to control the transceiver to
pause data transmission of the layer three communication connection;
transmit data via a second communication connection during the pausing of the data transmission of the layer three communication connection; and
resume transmission of data via the layer three communication connection after the transmission of data via the second communication connection is completed.

2. The communication terminal of claim 1, wherein the controller is configured to control the transceiver to establish the second communication connection.

3. The communication terminal of claim 1, wherein the second communication connection is a second layer three communication connection.

4. The communication terminal of claim 1, wherein the transceiver is configured to transmit the data via the layer three communication connection by means of a first radio access technology and the controller is configured to control the transceiver to transmit the data via the second communication connection during the pausing of the data transmission of the layer three communication connection by means of a second radio access technology different from the first radio access technology.

5. The communication terminal of claim 1, further comprising a first subscriber identity and a second subscriber identity, wherein the layer three communication connection is a communication connection established using the first subscriber identity and the second communication connection is a communication connection established using the second subscriber identity.

6. The communication terminal of claim 1, wherein the controller is configured to control the transceiver to keep the layer three communication connection established during the pausing of the data transmission of the layer three communication connection.

7. The communication terminal of claim 1, wherein the transceiver has an idle mode and a connected mode and the controller is configured to control the transceiver to stay in connected mode during the pausing of the data transmission of the layer three communication connection.

8. The communication terminal of claim 1, wherein the layer three communication connection is a layer three communication connection to a network component of a radio communication network and the controller is configured to control the transceiver to pause the data transmission of the layer three communication connection to keep the layer three communication connection established by the network component during the pausing of the data transmission of the layer three communication connection.

9. The communication terminal of claim 1, wherein the controller is configured to control the transceiver to pause the data transmission of the layer three communication connection for a short period of time to keep the layer three communication connection established by the network component during the pausing of the data transmission of the layer three communication connection.

10. The communication terminal of claim 1, wherein the controller is configured to control the transceiver to pause the data transmission of the layer three communication connection to keep a layer three communication connection context for the communication terminal established by the network component during the pausing of the data transmission of the layer three communication connection.

11. The communication terminal of claim 1, wherein the controller is configured to control the transceiver to pause the data transmission of the layer three communication connection for a short period of time to keep a layer three communication connection context for the communication terminal established by the network component during the pausing of the data transmission of the layer three communication connection.

12. The communication terminal of claim 11, wherein the layer three communication connection context includes a radio network temporary identifier of the communication terminal.

13. The communication terminal of claim 1, wherein the controller is configured to control the transceiver to pause the data transmission of the layer three communication connection and to transmit data via the second communication connection during the pausing of the data transmission of the layer three communication connection by controlling a physical layer transmitter component to switch from the transmission of data for the layer three communication connection to the transmission of data for the second communication connection for the duration of the pausing of the data transmission of the layer three communication connection.

14. The communication terminal of claim 1, wherein the transceiver is configured to transmit data via the layer three communication connection in accordance with a frame structure and wherein the controller is configured to control the transceiver to pause the data transmission of the layer three communication connection by omitting the transmission of data for complete frames, sub-frames, timeslots or symbols of the frame structure.

15. The communication terminal of claim 1, wherein the controller is configured to control the transceiver to pause the data transmission of the layer three communication connection by ignoring uplink transmission grants for data transmission of the layer three communication connection.

16. The communication terminal of claim 1, wherein controlling the transceiver to pause the data transmission of the layer three communication connection comprises leaving spectral communication resources allocated for data transmission of the layer three communication connection unused for data transmission of the layer three communication connection.

17. The communication terminal of claim 1, wherein controlling the transceiver to pause the data transmission of the layer three communication connection comprises deterring a resource allocation network component from assigning spectral communication resources for transmission via the layer three communication connection to the communication terminal.

18. The communication terminal of claim 1, wherein the communication terminal is a mobile device and wherein the layer three communication connection is a communication connection for a voice or data call.

19. The communication terminal of claim 1, wherein the second communication connection is a signaling connection.

20. The communication terminal of claim 1, wherein the communication terminal is a mobile device and wherein the second communication connection is a signaling connection for receiving data about a caller which has initiated a call to the communication terminal during the layer three communication connection.

21. The communication terminal of claim 1, wherein the communication terminal is a mobile device and wherein the second communication connection is a signaling connection for receiving a text message or transmitting a text message.

22. The communication terminal of claim 1, wherein the controller is configured to control the transceiver to resume data reception via the layer three communication connection during the pausing of the data transmission of the layer three communication connection.

23. The communication terminal of claim 1, wherein the data transmission of the layer three communication connection and the transmission via the second communication connection are uplink data transmissions to a base station of a cellular mobile communication network.

24. A method for performing a communication comprising:
establishing a layer three communication connection;
transmitting data via the layer three communication connection;
pausing data transmission of the layer three communication connection;
transmitting data via a second communication connection during the pausing of the data transmission of the layer three communication connection; and
continuing transmission of data via the layer three communication connection after the transmission of data via the second communication connection is completed.

25. A computer readable medium having recorded instructions thereon which, when executed by a processor, make the processor perform a method for controlling a data transmission according to claim 24.
